(19) United States
(12) Patent Application Publication
(10) Pub. No.: US 2025/0036839 A1
(43) Pub. Date: Jan. 30, 2025

(54) SEMICONDUCTOR DEVICE AND SEMICONDUCTOR SYSTEM INCLUDING THE SAME

(71) Applicant: SK hynix Inc., Gyeonggi-do (KR)

(72) Inventors: Jung Hyun KWON, Gyeonggi-do (KR); Min Seob LEE, Gyeonggi-do (KR)

(21) Appl. No.: 18/408,590

(22) Filed: Jan. 10, 2024

(30) Foreign Application Priority Data
Jul. 27, 2023 (KR) 10-2023-0098157

(51) Int. Cl. G06F 30/3312; G06F 30/3947; G06F 119/12

(52) U.S. Cl. CPC G06F 30/3312; G06F 30/3947; G06F 2119/12

(57) ABSTRACT

Disclosed is a semiconductor device and a semiconductor system including the same, the semiconductor device includes a plurality of pads, a data pattern analysis circuit configured to generate analysis signals by analyzing a data pattern of each of data mapped to each of the plurality of pads, a data remapping circuit configured to re-determine a relationship between the data and the plurality of pads based on the analysis signals, and remap the data to the plurality of pads based on the re-determined relationship, and an output circuit configured to output the remapped data through the plurality of pads.

### CROSS-REFERENCE TO RELATED APPLICATION(S)

This application claims priority under 35 U.S.C. § 119 to Korean Patent Application No. 10-2023-0098157, filed on Jul. 27, 2023, the disclosure of which is incorporated herein by reference in its entirety.

### BACKGROUND

### 1. Field

Various embodiments of the present disclosure relate to a semiconductor design technique, and more particularly, to a semiconductor device including an interface and a semiconductor system including the semiconductor device.

### 2. Description of the Related Art

A semiconductor system may include semiconductor devices, each of which may include an interface to transmit/receive signals among the semiconductor devices.

Since the semiconductor system operates at a high speed and is highly integrated, the frequency of occurrence of errors in the process of transmitting signals through the interface is increasing. The errors may occur due to various causes. One of the causes is crosstalk that occurs between transmission lines transmitting signals. That is, the crosstalk refers to unintentional distortion of the signals transmitted through physically adjacent transmission lines due to coupling therebetween.

### SUMMARY

Various embodiments of the present disclosure are directed to a semiconductor device that remaps (or reorders) signals and transmission lines when the signals are transmitted through the transmission lines, and a semiconductor system including the semiconductor device.

In accordance with an embodiment of the present disclosure, a semiconductor device may include: a plurality of pads; a data pattern analysis circuit configured to generate analysis signals by analyzing a data pattern of each of data mapped to each of the plurality of pads; a data remapping circuit configured to re-determine a relationship between the data and the plurality of pads based on the analysis signals, and remap the data to the plurality of pads based on the re-determined relationship; and an output circuit configured to output the remapped data through the plurality of pads.

In accordance with an embodiment of the present disclosure, an electronic device may include: a plurality of pads; and a processor configured to update a corresponding relationship between a plurality of data inputted thereto and the plurality of pads based on a data pattern of each of the plurality of data, and output a plurality of remapped data through respective corresponding pads among the plurality of pads based on the updated corresponding relationship.

In accordance with an embodiment of the present disclosure, a semiconductor system may include: a first semiconductor device configured to calculate a crosstalk score of a plurality of first data based on a predetermined remapping strategy, re-determine a corresponding relationship between the plurality of first data and a plurality of first pads based on the crosstalk score, and generate a plurality of remapped data corresponding to the plurality of first data according to the re-determined corresponding relationship; and a second semiconductor device configured to receive the plurality of remapped data and generate a plurality of second data corresponding to the plurality of first data.

### BRIEF DESCRIPTION OF THE DRAWINGS

FIG. 1 is a block diagram illustrating a semiconductor system in accordance with an embodiment of the present disclosure.

FIG. 2 is a block diagram illustrating a transmitter shown in FIG. 1.

FIG. 3 is a block diagram illustrating a first processor shown in FIG. 2.

FIG. 4 is a block diagram illustrating a receiver shown in FIG. 1.

FIG. 5 is a block diagram illustrating a second processor shown in FIG. 4.

FIGS. 6 and 7 are diagrams illustrating an operation of an image sensor in accordance with an embodiment of the present disclosure.

### DETAILED DESCRIPTION

Various embodiments of the present disclosure are described below with reference to the accompanying drawings, in order to describe in detail the present disclosure so that those with ordinary skill in art to which the present disclosure pertains may easily carry out the technical spirit of the present disclosure.

It will be understood that when an element is referred to as being “connected to” or “coupled to” another element, the element may be directly connected to or coupled to another element, or electrically connected to or coupled to the another element with one or more elements interposed therebetween. In addition, it will also be understood that the terms “comprises,” “comprising,” “includes,” and “including” when used in this specification do not preclude the presence of one or more other elements but may further include or have the one or more other elements, unless otherwise mentioned. In the description throughout this specification, some components are described in singular forms, but the present disclosure is not limited thereto, and it will be understood that the components may be formed in plural.

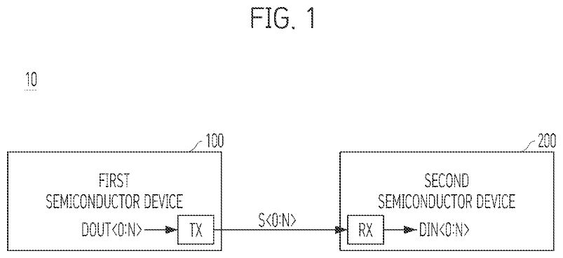

FIG. 1 is a block diagram illustrating a semiconductor system 10 in accordance with an embodiment of the present disclosure.

Referring to FIG. 1, the semiconductor system 10 may include a first semiconductor device 100 and a second semiconductor device 200. Each of the first and second semiconductor devices 100 and 200 may be an electronic device. In an embodiment, the electronic device may denote a device including a semiconductor device or a device included in the semiconductor device.

The first semiconductor device 100 may calculate a crosstalk score of data DOUT<0:N> on the basis of a predetermined remapping strategy, where “N” is a natural number. The crosstalk score is a numerical value of factors affecting crosstalk that occurs between the data DOUT<0:N>. The first semiconductor device 100 may re-determine or update a relationship (e.g., a corresponding relationship) between the data DOUT<0:N> and first pads on the basis of the crosstalk score, and generate transmission data S<0:N> respectively corresponding to the data DOUT<0:N> according to the re-determined or updated corresponding relationship. The output data DOUT<0:N> may include a plurality of data, i.e., N+1 bits.

The first semiconductor device 100 may include a transmitter TX. The transmitter TX may generate the transmission data S<0:N> on the basis of the data DOUT<0:N>.

The second semiconductor device 200 may receive the transmission data S<0:N>, and generate data DIN<0:N> respectively corresponding to the data DOUT<0:N>.

The second semiconductor device 200 may include a receiver RX. The receiver RX may generate the data DIN<0:N> on the basis of the transmission data S<0:N>.

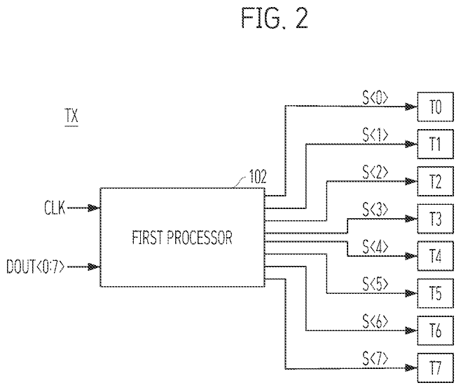

FIG. 2 is a block diagram illustrating the transmitter TX included in the first semiconductor device 100 shown in FIG. 1. For example, FIG. 2 illustrates first to eighth pads T0 to T7, that is, N=7.

Referring to FIG. 2, the transmitter TX may include a first processor 102 and the first to eighth pads T0 to T7.

The first processor 102 may re-determine or update a corresponding relationship between first to eighth data DOUT<0:7> and the first to eighth pads T0 to T7 on the basis of respective data patterns of the first to eighth data DOUT<0:7>, and output the first to eighth data DOUT<0:7> through the respective corresponding pads among the first to eighth pads T0 to T7, on the basis of the re-determined or updated corresponding relationship.

The first pad T0 may transmit a rearranged first transmission data S<0> of the first to eighth data DOUT<0:7> to the second semiconductor device 200.

The second pad T1 may transmit a rearranged second transmission data S<1> of the first to eighth data DOUT<0:7> to the second semiconductor device 200.

The third pad T2 may transmit a rearranged third transmission data S<2> of the first to eighth data DOUT<0:7> to the second semiconductor device 200.

The fourth pad T3 may transmit a rearranged fourth transmission data S<3> of the first to eighth data DOUT<0:7> to the second semiconductor device 200.

The fifth pad T4 may transmit a rearranged fifth transmission data S<4> of the first to eighth data DOUT<0:7> to the second semiconductor device 200.

The sixth pad T5 may transmit a rearranged sixth transmission data S<5> of the first to eighth data DOUT<0:7> to the second semiconductor device 200.

The seventh pad T6 may transmit a rearranged seventh transmission data S<6> of the first to eighth data DOUT<0:7> to the second semiconductor device 200.

The eighth pad T7 may transmit a rearranged eighth transmission data S<7> of the first to eighth data DOUT<0:7> to the second semiconductor device 200.

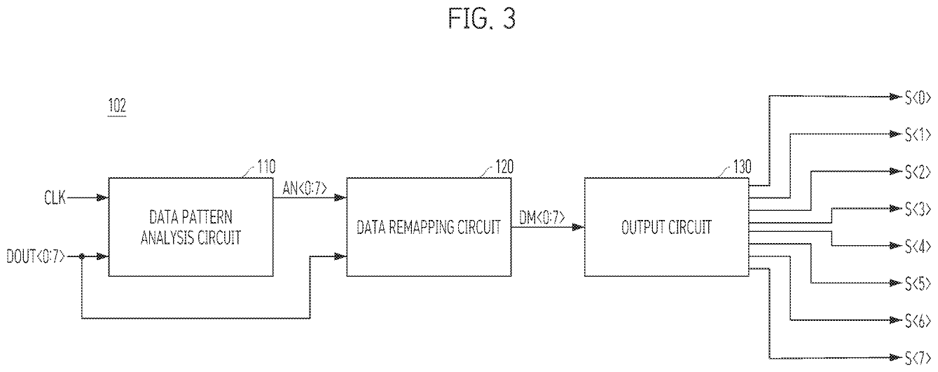

FIG. 3 is a block diagram illustrating the first processor 102 shown in FIG. 2.

Referring to FIG. 3, the first processor 102 may include a data pattern analysis circuit 110, a data remapping circuit 120, and an output circuit 130.

The data pattern analysis circuit 110 may generate first to eighth analysis signals AN<0:7> by analyzing a data pattern of each of the first to eighth data DOUT<0:7> mapped to each of the first to eighth pads T0 to T7 for each cycle of a clock signal CLK on the basis of the clock signal CLK and the first to eighth data DOUT<0:7> and generate first to eighth analysis signals AN<0:7> corresponding to the analysis result. The first to eighth analysis signals AN<0:7> and the first to eighth data DOUT<0:7> may correspond one to one. The first to eighth analysis signals AN<0:7> may include map information related to the respective number of times that the first to eighth data DOUT<0:7> transition.

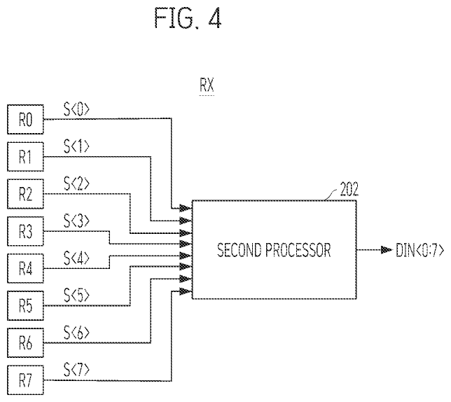

The map information may include the number of valid data #1's having a high logic level in each of the first to eighth data DOUT<0:7>, the number of valid data #0's having a low logic level in each of the first to eighth data DOUT<0:7>, the number of times #post_odd that each of the first to eighth data DOUT<0:7> transitions from the low logic level to the high logic level in odd-numbered cycles of the clock signal CLK, the number of times #post_even that each of the first to eighth data DOUT<0:7> transitions from the low logic level to the high logic level in even-numbered cycles of the clock signal CLK, the number of times #negt_odd that each of the first to eighth data DOUT<0:7> transitions from the high logic level to the low logic level in the odd-numbered cycles of the clock signal CLK, the number of times #negt_even that each of the first to eighth data DOUT<0:7> transitions from the high logic level to the low logic level in the even-numbered cycles of the clock signal CLK, and the total number of times tot_tran that each of the first to eighth data DOUT<0:7> transitions (refer to FIG. 4).

The data remapping circuit 120 may re-determine the corresponding relationship on the basis of the first to eighth analysis signals AN<0:7> and the first to eighth data DOUT<0:7>, and generate first to eighth remapped data DM<0:7> respectively corresponding to the first to eighth data DOUT<0:7> according to the re-determined corresponding relationship. The first to eighth remapped data DM<0:7> and the first to eighth data DOUT<0:7> may correspond one to one. Namely, the data remapping circuit 120 may remap the first to eighth data DOUT<0:7> to the first to eighth pads T0 to T7 according to the first to eighth analysis signals AN<0:7>.

The output circuit 130 may output the first to eighth transmission data S<0:7> through the first to eighth pads T0 to T7 on the basis of the first to eighth remapped data DM<0:7>. The first to eighth transmission data S<0:7> correspond to the first to eighth remapped data DM<0:7>.

FIG. 4 is a block diagram illustrating the receiver RX included in the second semiconductor device 200 shown in FIG. 1. For example, FIG. 4 illustrates first to eighth pads R0 to R7, that is, N=7.

Referring to FIG. 4, the receiver RX may include the first to eighth pads R0 to R7 and a second processor 202.

The first pad R0 may receive the rearranged first transmission data S<0> from the first semiconductor device 100.

The second pad R1 may receive the rearranged second transmission data S<1> from the first semiconductor device 100.

The third pad R2 may receive the rearranged third transmission data S<2> from the first semiconductor device 100.

The fourth pad R3 may receive the rearranged fourth transmission data S<3> from the first semiconductor device 100.

The fifth pad R4 may receive the rearranged fifth transmission data S<4> from the first semiconductor device 100.

The sixth pad R5 may receive the rearranged sixth transmission data S<5> from the first semiconductor device 100.

The seventh pad R6 may receive the rearranged seventh transmission data S<6> from the first semiconductor device 100.

The eighth pad R7 may receive the rearranged eighth transmission data S<7> from the first semiconductor device 100.

The second processor 202 may generate first to eighth data DIN<0:7> whose arrangement order is restored, on the basis of the rearranged first to eighth transmission data S<0:7> inputted through the first to eighth pads R0 to R7, respectively.

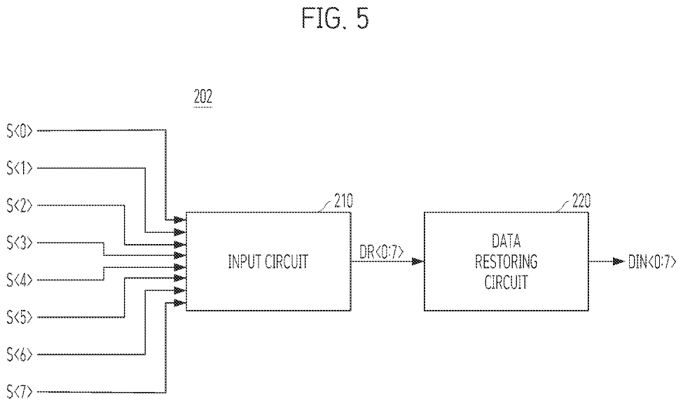

FIG. 5 is a block diagram illustrating the second processor 202 shown in FIG. 4.

Referring to FIG. 5, the second processor 202 may include an input circuit 210 and a data restoring circuit 220.

The input circuit 210 may generate first to eighth input data DR<0:7> on the basis of the first to eighth transmission data S<0:N> inputted through the first to eighth pads R0 to R7, respectively.

The data restoring circuit 220 may receive the first to eighth input data DR<0:7>. The data restoring circuit 220 may restore an arrangement order of the first to eighth input data DR<0:7> on the basis of map information included in each of the first to eighth input data DR<0:7>, thereby generating the first to eighth data DIN<0:7>. An arrangement order of the first to eighth data DIN<0:7> may be the same as an arrangement order of the first to eighth data DOUT<0:7> of the first semiconductor device 100.

The map information may include whether or not each of the first to eighth data DOUT<0:7> is inverted, and a previous (i.e., original) arrangement order of each of the first to eighth data DOUT<0:7>. The map information may be recorded in a header of each of the first to eighth data DOUT<0:7>.

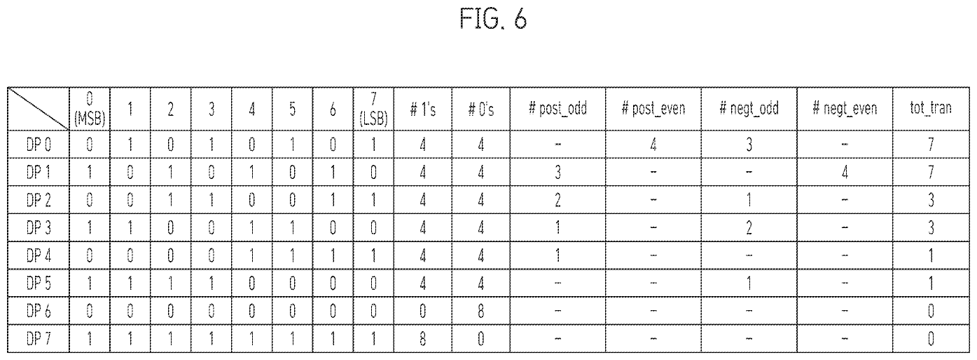

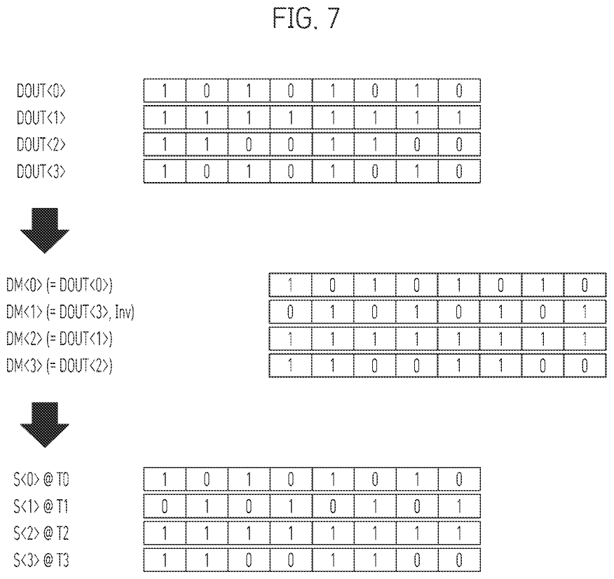

Hereinafter, an operation of the semiconductor system 10 according to an embodiment of the present disclosure, which has the above-described configuration, is described with reference to FIGS. 6 and 7.

The first semiconductor device 100 may output the transmission data S<0:N> corresponding to the data DOUT<0:N> to the second semiconductor device 200. In this case, the first semiconductor device 100 may rearrange transmission paths of the data DOUT<0:N> to minimize crosstalk occurring between the transmission data S<0:N>. For example, the transmitter TX included in the first semiconductor device 100 may calculate the crosstalk score of the data DOUT<0:N> on the basis of the predetermined remapping strategy, re-determine a corresponding relationship between the data DOUT<0:N> and the pads T0 to T7 on the basis of the crosstalk score, and generate the transmission data S<0:N> corresponding to the data DOUT<0:N> according to the re-determined corresponding relationship.

The remapping strategy may be referenced by the data remapping circuit 120 and follows the descriptions below.

(1) The data DOUT<0:N> may be rearranged so that data having a differential relationship or a pseudo differential relationship among the data DOUT<0:N> are transmitted adjacent to each other, i.e., neighboring each other. The pseudo differential relationship may mean that a relationship between two data is substantially the same as or similar to the differential relationship. For example, the data DOUT<0:N> may be rearranged so that data having a relatively large number of times #post_odd or #post_even that the data transitions from the low logic level to the high logic level and data having a relatively large number of times #negt_odd or #negt_even that the data transitions from the high logic level to the low logic level are transmitted adjacent to each other.

(2) Among the data DOUT<0:N>, the data DOUT<0:N> may be rearranged so that data having the largest number of times that the data transitions and data having the smallest number of times that the data transitions are transmitted adjacent to each other. For example, the data having the smallest number of times that the data transitions may be static data that has never transitioned.

(3) The data DOUT<0:N> may be rearranged so that data having the same pattern or similar data patterns among the data DOUT<0:N> are not transmitted adjacent to each other.

(4) At least one of the data DOUT<0:N> may be inverted. This may be in the same context as “(1)” above. As at least one of two or more pieces of data having similar data patterns is inverted, the two or more pieces of data may have the differential relationship or the pseudo differential relationship.

FIG. 6 is a table for describing the crosstalk score. For example, FIG. 6 illustrates first to eighth data patterns DP0 to DP7, and each of the first to eighth data patterns DP0 to DP7 may have eight burst lengths, that is, 8 bits.

Referring to FIG. 6, when the first data pattern DP0 is “01010101”, the number of valid data #1's having a low logic level is “4”, the number of valid data #0's having a high logic level is “4”, the number of times #post_odd that data transitions in a positive edge manner in the odd-numbered cycles of the clock signal CLK is “0”, the number of times #post_even that data transitions in the positive edge manner in the even-numbered cycles of the clock signal CLK is “4”, the number of times #negt_odd that data transitions in a negative edge manner in the odd-numbered cycles of the clock signal CLK is “3”, the number of times #negt_even that data transitions in the negative edge manner in the even-numbered cycles of the clock signal CLK is “0”, and the total number of times tot_tran that data transitions is “7”.

When the second data pattern DP1 is “10101010”, the number of valid data #1's having the low logic level is “4”, the number of valid data #0's having the high logic level is “4”, the number of times #post_odd that data transitions in the positive edge manner in the odd-numbered cycles of the clock signal CLK is “3”, the number of times #post_even that data transitions in the positive edge manner in the even-numbered cycles of the clock signal CLK is “0”, the number of times #negt_odd that data transitions in the negative edge manner in the odd-numbered cycles of the clock signal CLK is “0”, the number of times #negt_even that data transitions in the negative edge manner in the even-numbered cycles of the clock signal CLK is “4”, and the total number of times tot_tran that data transitions is “7”.

When the third data pattern DP2 is “00110011”, the number of valid data #1's having the low logic level is “4”, the number of valid data #0's having the high logic level is “4”, the number of times #post_odd that data transitions in the positive edge manner in the odd-numbered cycles of the clock signal CLK is “2”, the number of times #post_even that data transitions in the positive edge manner in the even-numbered cycles of the clock signal CLK is “0”, the number of times #negt_odd that data transitions in the negative edge manner in the odd-numbered cycles of the clock signal CLK is “1”, the number of times #negt_even that data transitions in the negative edge manner in the even-numbered cycles of the clock signal CLK is “0”, and the total number of times tot_tran that data transitions is “3”.

When the fourth data pattern DP3 is “11001100”, the number of valid data #1's having the low logic level is “4”, the number of valid data #0's having the high logic level is “4”, the number of times #post_odd that data transitions in the positive edge manner in the odd-numbered cycles of the clock signal CLK is “1”, the number of times #post_even that data transitions in the positive edge manner in the even-numbered cycles of the clock signal CLK is “0”, the number of times #negt_odd that data transitions in the negative edge manner in the odd-numbered cycles of the clock signal CLK is “2”, the number of times #negt_even that data transitions in the negative edge manner in the even-numbered cycles of the clock signal CLK is “0”, and the total number of times tot_tran that data transitions is “3”.

When the fifth data pattern DP4 is “00001111”, the number of valid data #1's having the low logic level is “4”, the number of valid data #0's having the high logic level is “4”, the number of times #post_odd that data transitions in the positive edge manner in the odd-numbered cycles of the clock signal CLK is “1”, the number of times #post_even that data transitions in the positive edge manner in the even-numbered cycles of the clock signal CLK is “0”, the number of times #negt_odd that data transitions in the negative edge manner in the odd-numbered cycles of the clock signal CLK is “0”, the number of times #negt_even that data transitions in the negative edge manner in the even-numbered cycles of the clock signal CLK is “0”, and the total number of times tot_tran that data transitions is “1”.

When the sixth data pattern DP5 is “11110000”, the number of valid data #1's having the low logic level is “4”, the number of valid data #0's having the high logic level is “4”, the number of times #post_odd that data transitions in the positive edge manner in the odd-numbered cycles of the clock signal CLK is “0”, the number of times #post_even that data transitions in the positive edge manner in the even-numbered cycles of the clock signal CLK is “0”, the number of times #negt_odd that data transitions in the negative edge manner in the odd-numbered cycles of the clock signal CLK is “1”, the number of times #negt_even that data transitions in the negative edge manner in the even-numbered cycles of the clock signal CLK is “0”, and the total number of times tot_tran that data transitions is “1”.

When the seventh data pattern DP6 is “00000000”, the number of valid data #1's having the low logic level is “0”, the number of valid data #0's having the high logic level is “8”, the number of times #post_odd that data transitions in the positive edge manner in the odd-numbered cycles of the clock signal CLK is “0”, the number of times #post_even that data transitions in the positive edge manner in the even-numbered cycles of the clock signal CLK is “0”, the number of times #negt_odd that data transitions in the negative edge manner in the odd-numbered cycles of the clock signal CLK is “0”, the number of times #negt_even that data transitions in the negative edge manner in the even-numbered cycles of the clock signal CLK is “0”, and the total number of times tot_tran that data transitions is “0”.

When the eighth data pattern DP5 is “11111111”, the number of valid data #1's having the low logic level is “8”, the number of valid data #0's having the high logic level is “0”, the number of times #post_odd that data transitions in the positive edge manner in the odd-numbered cycles of the clock signal CLK is “0”, the number of times #post_even that data transitions in the positive edge manner in the even-numbered cycles of the clock signal CLK is “0”, the number of times #negt_odd that data transitions in the negative edge manner in the odd-numbered cycles of the clock signal CLK is “0”, the number of times #negt_even that data transitions in the negative edge manner in the even-numbered cycles of the clock signal CLK is “0”, and the total number of times tot_tran that data transitions is “0”.

FIG. 7 is a diagram for describing in more detail an operation of the transmitter TX included in the first semiconductor device 100. For example, FIG. 7 illustrates just the first to fourth data DOUT<0:3> and data DM<0:3> and S<0:3> related thereto.

As illustrated in FIG. 7, the data pattern of the first data DOUT<0> is “10101010”, the data pattern of the second data DOUT<1> is “11111111”, the data pattern of the third data DOUT<2> is “11001100”, and the data pattern of the fourth data DOUT<3> is “10101010”.

Since the first data DOUT<0> and the fourth data DOUT<3> have the same data pattern, the first data DOUT<0> and the fourth data DOUT<3> may be disposed not to be adjacent to each other, or one of the first data DOUT<0> or the fourth data DOUT<3> may be inverted. Since there is no data corresponding to a differential relationship or pseudo differential relationship with the first data DOUT<0> among the second and third data DOUT<1:2>, it is preferable that one of the first data DOUT<0> and the fourth data DOUT<3> is inverted. In an embodiment, it is described that the fourth data DOUT<3> is inverted. Accordingly, the data remapping circuit 120 may generate the first remapped data DM<0> corresponding to the first data DOUT<0>, and generate the second remapped data DM<1> corresponding to inverted data of the fourth data DOUT<3>(to which “(1), (3), and (4)” of the remapping strategy are applied). In this case, the first remapped data DM<0> may include information on the first data DOUT<0> and non-inversion information as map information, and the second remapped data DM<1> may include information on the fourth data DOUT<3> and inversion information Inv as map information.

Since the second data DOUT<1> is a static signal, the second data DOUT<1> may be disposed to be adjacent to data with a large number of times transitioning. The third data DOUT<2> may be disposed to be adjacent to the static data because there is no data corresponding to the differential relationship or pseudo differential relationship with the third data DOUT<2> among the first, second, and fourth data DOUT<0:1> and DOUT<3>. Accordingly, the data remapping circuit 120 may generate the third remapped data DM<2> corresponding to the second data DOUT<1> and generate the fourth remapped data DM<3> corresponding to the third data DOUT<2>(to which “(2) and (3)” of the remapping strategy are applied). In this case, the third remapped data DM<2> may include information on the second data DOUT<1> and non-inversion information as map information, and the fourth remapped data DM<3> may include information on the third remapped data DM<3> and non-inversion information as map information.

The output circuit 130 may output the first to fourth transmission data S<0:3> corresponding to the first to fourth remapped data DM<0:3> to the second semiconductor device 200 through the first to fourth pads T0 to T3. As described above, the first to fourth transmission data S<0:3> are transmitted through the transmission paths coupled to the first to fourth pads T0 to T3 while being rearranged on the basis of the remapping strategy, and therefore, the crosstalk occurring between the first to fourth transmission data S<0:3> may be minimized.

According to an embodiment of the present disclosure, data having a data pattern that is resistant to crosstalk may be rearranged to be transmitted adjacent to each other, which makes it possible to improve transmission efficiency of the data.

According to an embodiment of the present disclosure, distortion of data caused by crosstalk may be suppressed when the data are transmitted through transmission lines, which makes it possible to improve quality of the data.

While the present disclosure has been illustrated and described with respect to specific embodiments, the disclosed embodiments are provided for description and are not intended to be restrictive. Further, it is noted that the present disclosure may be achieved in various ways through substitution, change, and modification that fall within the scope of the following claims, as those skilled in the art will recognize in light of the present disclosure. Furthermore, the embodiments may be combined to form additional embodiments.

What is claimed is:

1. A semiconductor device comprising:
a plurality of pads;
a data pattern analysis circuit configured to generate analysis signals by analyzing a data pattern of each of data mapped to each of the plurality of pads;
a data remapping circuit configured to re-determine a relationship between the data and the plurality of pads based on the analysis signals, and remap the data to the plurality of pads based on the re-determined relationship; and
an output circuit configured to output the remapped data through the plurality of pads.

2. The semiconductor device of claim 1, wherein each of the analysis signals includes map information related to a number of times that each of the data transitions.

3. The semiconductor device of claim 2, wherein the map information includes at least one of a number of valid data having a low logic level in each of the data, a number of valid data having a high logic level in each of the data, a number of times that each of the data transitions from the low logic level to the high logic level in odd-numbered cycles of a clock signal, a number of times that each of the data transitions from the low logic level to the high logic level in even-numbered cycles of the clock signal, a number of times that each of the data transitions from the high logic level to the low logic level in the odd-numbered cycles of the clock signal, a number of times that each of the data transitions from the high logic level to the low logic level in the even-numbered cycles of the clock signal, and a total number of times that each of the data transitions.

4. The semiconductor device of claim 1, wherein the data remapping circuit is configured to remap the data based on the analysis signals so that data having a differential relationship or a pseudo differential relationship among the data are transmitted adjacent to each other.

5. The semiconductor device of claim 4, wherein the data remapping circuit is configured to remap the data so that data having a relatively large number of times that the data transitions from a low logic level to a high logic level and data having a relatively large number of times that the data transitions from the high logic level to the low logic level are transmitted adjacent to each other.

6. The semiconductor device of claim 1, wherein the data remapping circuit is configured to remap the data based on the analysis signals so that data having a largest number of times that the data transitions and data having a smallest number of times that the data transitions among the data are transmitted adjacent to each other.

7. The semiconductor device of claim 1, wherein the data remapping circuit is configured to invert at least one data of the data based on the analysis signals.

8. The semiconductor device of claim 1, wherein each of the remapped data includes map information including whether each of the data is inverted and a previous arrangement order of each of the data.

9. The semiconductor device of claim 1, wherein the data pattern analysis circuit is configured to analyze the data pattern of each of the data for each cycle of a clock signal, and generate the analysis signals corresponding to the analysis result.

10. The semiconductor device of claim 1, wherein the data remapping circuit is configured to generate the remapped data corresponding to the data according to the re-determined relationship.

11. An electronic device comprising:
a plurality of pads; and
a processor configured to update a corresponding relationship between a plurality of data inputted thereto and the plurality of pads based on a data pattern of each of the plurality of data, and output a plurality of remapped data through respective corresponding pads among the plurality of pads based on the updated corresponding relationship.

12. The electronic device of claim 11, wherein the processor includes:
a data pattern analysis circuit configured to generate analysis signals by analyze the data pattern of each of the plurality of data mapped to each of the plurality of pads;
a data remapping circuit configured to update the corresponding relationship between the plurality of data and the plurality of pads based on the analysis signals, and remap the plurality of data to the plurality of pads based on the updated corresponding relationship; and
an output circuit configured to output a plurality of remapped data through the plurality of pads.

13. The electronic device of claim 12, wherein each of the analysis signals includes map information related to a number of times that each of the plurality of data transitions.

14. The electronic device of claim 13, wherein the map information includes at least one of a number of valid data having a low logic level in each of the plurality of data, a number of valid data having a high logic level in each of the plurality of data, a number of times that each of the plurality of data transitions from the low logic level to the high logic level in odd-numbered cycles of a clock signal, a number of times that each of the plurality of data transitions from the low logic level to the high logic level in even-numbered cycles of the clock signal, a number of times that each of the plurality of data transitions from the high logic level to the low logic level in the odd-numbered cycles of the clock signal, a number of times that each of the plurality of data transitions from the high logic level to the low logic level in the even-numbered cycles of the clock signal, and a total number of times that each of the plurality of data transitions.

15. The electronic device of claim 12,
wherein the data remapping circuit is configured to remap the plurality of data based on the analysis signals so that data having a differential relationship or a pseudo differential relationship among the plurality of data are transmitted adjacent to each other, and
wherein the data remapping circuit is configured to remap the plurality of data so that data having a relatively large number of times that the data transitions from a low logic level to a high logic level and data having a relatively large number of times that the data transitions from the high logic level to the low logic level among the plurality of data are transmitted adjacent to each other.

16. The electronic device of claim 12, wherein the data remapping circuit is configured to perform at least one of 1) an operation of remapping the plurality of data based on the analysis signals so that data having a largest number of times that the data transitions and data having a smallest number of times that the data transitions among the plurality of data are transmitted adjacent to each other and 2) an operation of inverting at least one of the plurality of data based on the analysis signals.

17. The electronic device of claim 12, wherein each of the plurality of mapped data includes map information including whether each of the plurality of data is inverted and a previous arrangement order of each of the plurality of data.

18. The electronic device of claim 12,
wherein the data pattern analysis circuit is configured to analyze the data pattern of each of the plurality of data for each cycle of a clock signal based on the clock signal, and generate the analysis signals corresponding to the analysis result, and
wherein the data remapping circuit is configured to generate the plurality of remapped data corresponding to the plurality of data according to the corresponding relationship.

19. A semiconductor system comprising:
a first semiconductor device configured to calculate a crosstalk score of a plurality of first data based on a predetermined remapping strategy, re-determine a corresponding relationship between the plurality of first data and a plurality of first pads based on the crosstalk score, and generate a plurality of remapped data corresponding to the plurality of first data according to the re-determined corresponding relationship; and
a second semiconductor device configured to receive the plurality of remapped data and generate a plurality of second data corresponding to the plurality of first data.

20. The semiconductor system of claim 19, wherein the second semiconductor device includes:
an input circuit configured to generate a plurality of input data based on the plurality of remapped data inputted through second pads; and
a data restoring circuit configured to receive the plurality of input data, and restore an arrangement order of the plurality of input data based on map information included in the plurality of input data to generate the plurality of second data.
